(19) United States
(12) Patent Application Publication
(10) Pub. No.: US 2003/0127765 A1
(43) Pub. Date: Jul. 10, 2003

(54) Extrusion composite compression injection process and apparatus

(76) Inventors: Richard A. Weiland, Crestline, CA (US); Sing-Lit Jim, Alhambra, CA (US); Roger Wang, Upland, CA (US)

Correspondence Address: ARTER & HADDEN, LLP, 1100 HUNTINGTON BUILDING, 925 EUCLID AVENUE, CLEVELAND, OH, 44115-1475, US

(21) Appl. No.: 10/219,918

(22) Filed: Aug. 15, 2002

Related U.S. Application Data
(60) Provisional application No. 60/312,723, filed on Aug. 16, 2001.

(51) Int. Cl. B29C 43/02; B29C 43/04; B29C 43/18; B29C 43/20

(52) U.S. Cl. 264/69; 264/320; 264/323; 264/308; 264/255; 264/297.8; 264/245; 264/293; 264/132; 264/310; 264/259; 264/279; 264/138; 425/130; 425/131.1; 425/258

(57) ABSTRACT

A molding process and apparatus are disclosed herewith including extruding a polymer from at least one nozzle into a mold cavity, and displacing at least one of the nozzle and the mold cavity during the step of extruding to deposit at least a portion of a layer of polymer into the mold cavity, and subsequently enclosing the mold cavity with a mating mold section to produce a molded part.

### CROSS REFERENCE TO RELATED APPLICATIONS

The present invention claims the benefit of U.S. Provisional Application No. 60/312,723, filed Aug. 16, 2001.

### BACKGROUND OF THE INVENTION

The present invention is directed to the field of extrusion compression injection technology, suitable for molding a large variety of articles of polymer materials. The present invention has particular applicability for molding articles that require special materials and physical properties, including: high strength; multi-layers (including encased foamed core); mixed polymer materials (virgin, widespec, and recycled polymers); special in-lays, over-lays, inserts, and/or in-mold insert of objects to be on the inside or the outside of polymer article; special additives; and special finish outside layers.

It is known that in traditional high-pressure injection molding, polymer is injected through narrow ports to fill the mold cavity, usually to fabricate thin-walled parts. The polymer is injected with high pressure to assure a fast and proper fill. Under such circumstance, the polymer undergoes a tremendous amount of stress that results in the deterioration of the strength of materials and the profusion of stress lines that weakens the structural integrity of the article. It is also known to use multi-nozzles for low-pressure injection (e.g. for fabricating with low pressure structural foam) to reduce stress in polymer contributed by injection pressure. However, weld lines still exist between material masses injected through the various injection ports. These are again lines of structural weaknesses that could weaken the strength of polymer article. In both processes, the polymer still has to be pushed through one or more relatively narrow nozzle openings. Thus, the polymer that can be used is limited to higher melt index polymer, which generally has a lower strength factor than polymer of a lower melt index.

In traditional compression molding, polymer is poured into an open mold and compressed into form. The problem with this technology is that the polymer mass is still being pressed and spread throughout the mold, causing stress, line of weaknesses, and possible warpage that may compromise the article. Another problem with this and other regular injection technology is that the polymer is a single homogeneous material and does not have the ability to fashion individual layers for the unique functionalities.

In a sheet forming process, polymer is extruded & rolled into a sheet as it is cooled. The drawback with this process is that it cannot mold parts into different shapes other than sheets.

In many polymer applications, it is often difficult and/or expensive to incorporate special functionalities into polymer articles. Special functions can include UV protection, anti-static, color, high strength, barrier, fire retardancy, and foam for impact and/or insulation. Take the case of fire retardancy for example. Not only is the fire retardant additive very expensive, the resulting polymer with the additive also tends to have a very brittle physical property. For similar reasons, it is often not desirable to blend additives in throughout the complete part and such blending throughout the polymer sometimes creates problem with additional cost and deterioration of chemical and physical properties of polymer.

Similarly, it would be desirable to use a combination of different polymers in a part because of speed, engineering, aesthetic, economic, ecological, and/or health and safety reasons etc., such as the mixed use of HDPE, HDPP, nylon, and other engineering plastics, or that of virgin and recycled polymers. However, in most of the traditional injection and compression molding processes, mixed use of polymers is limited to a low degree of mixing in term of ratios because many of them just do not mix well, such as nylon with HDPE etc. At the same time, aspects of physical integrity of mixed polymers may be compromised too much when mixed in higher ratios.

There is a co-extrusion process of blow-molding bottles and other small parts. The disadvantage of blow-molding co-extrusion is the relative limitation of the size of article that can be made and the type of materials that can be used and co-mingled because of the hang-strength and the frequent absence of relative bonding affinity of layers in relation to each other. In addition, the nature of a polymer parison limits the co-extrusion to be in layer formation only, precluding the possibilities for forming structural elements or other special members, such as ribs, strips, clumps and other special formations of different polymers, as would be desirable for engineering, aesthetic, economic, ecological, and/or health and safety reasons, etc.

In a typical co-extrusion process, it is very difficult to independently vary the extrusion rate of individual polymer at will while extruding. This limits the machine's ability to accurately and independently vary the amount and thickness of each layer to better custom tailor the characteristic of finish products.

During the molding process of a part, it could be desirable to in-mold a foreign object into and onto the part, such as the fastening screw head of a polymer hinge etc. However, the nature of such in-molding with injection and extrusion processes makes it very difficult to insert anything other than something that is relatively small. It is not possible to introduce special in-lays, over-lays, or inserts, and no provision is obtainable for extensive in-mold introduction of objects and or materials to be on the inside and outside of a polymer article.

It is known that many polymer additives deteriorate from the long heat and/or high shear as it is grinded through the harsh environment of an extruder and/or accumulator. For example, fiberglass strands are sheared down to short length while being pushed through the extruder screw. At the same time, it would not always be desirable to blend in an additive throughout the complete part since such blending might add additional cost and deterioration of physical properties including strength.

For certain engineering, aesthetic, economic, ecological, and/or health and safety reasons, etc. it might be desirable to have a special outside layer for a polymer article. However, it is very difficult to achieve such a layer, particularly if a thin uniform outside layer is required.

### SUMMARY OF THE INVENTION

Understanding the obstacles, problems and drawbacks associated with the current molding technologies and the limitation with manufacturing of products, it is advantageous and necessary for a new process that can overcome these barriers when making molded articles both large and small. The difficulties and drawbacks of previous-type devices are overcome by the molding process and apparatus of the present invention, including extruding a polymer from at least one nozzle into a mold cavity, and displacing at least one of the nozzle and the mold cavity during the step of extruding to deposit at least a portion of a layer of polymer into the mold cavity, and subsequently enclosing the mold cavity with a mating mold section to produce a molded part.

As will be realized, the invention is capable of other and different embodiments and its several details are capable of modifications in various respects, all without departing from the invention. Accordingly, the drawing and description are to be regarded as illustrative and not restrictive.

### BRIEF DESCRIPTION OF THE DRAWINGS

FIG. 1A is an overhead view of the polymer molding apparatus of the present invention.

FIGS. 1B, 1C, ID, 1E, 1F, 1G, 1H and 1I are detail views of various realizations of the nozzle mechanism in accordance with the present invention.

FIG. 2 is a side view showing the configuration and operation of the molding press in accordance with the present invention.

### DETAILED DESCRIPTION OF THE INVENTION

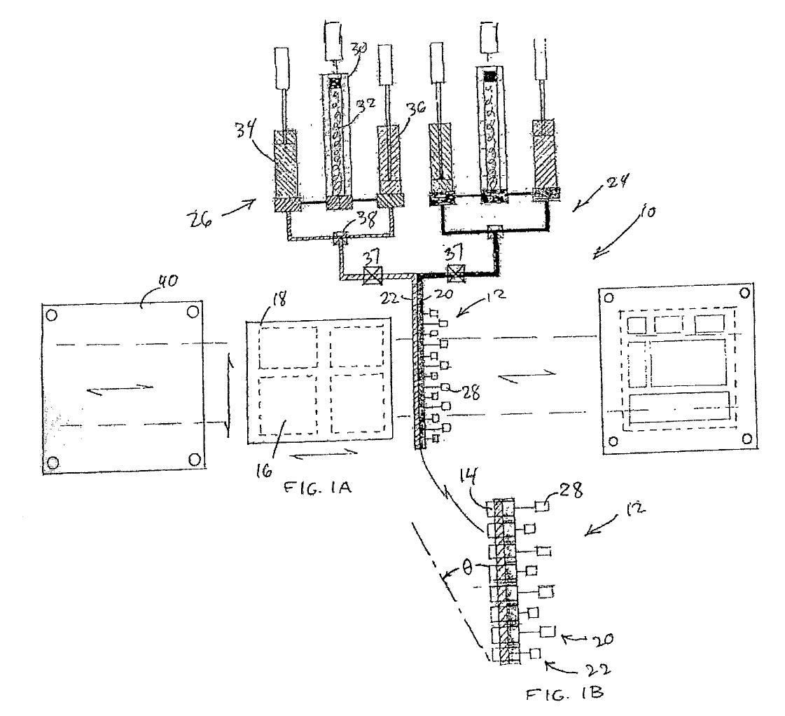

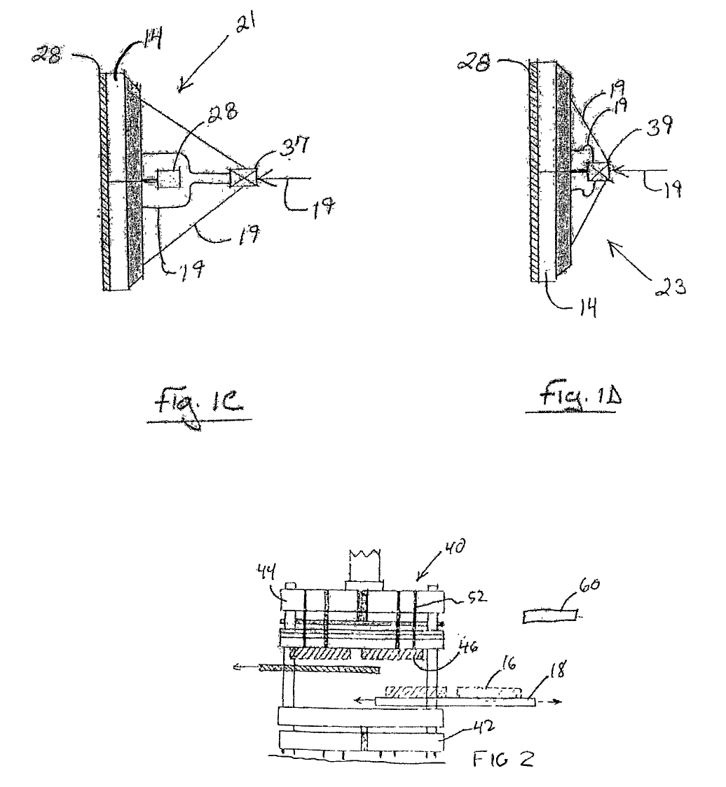

The present invention is directed to a compression injection process for the forming of both large and small objects having multiple layers, to obtain products, benefits and flexibilities not available with traditional processes. As shown in FIGS. 1A and 1B, the present molding apparatus employs a nozzle mechanism for laying down one or more types of polymer materials onto a bed having one or more open mold cavities.

The limitations for traditional processes include preventing the forming of products with the desired strength, size and varieties. In using the present Extrusion Composite Compression Injection Process, the inability of traditional compression processes to produce evenly-layered parts is eliminated by having multi-row extrusion mechanism lined up alongside each other that can move quickly relative to the mold table for an even and efficient filling of polymers of one or more different materials. The present process also allows the ability to extrude different composite layers, including the extrusion of bonding materials, used to provide bonding between layers that are normally incompatible in the traditional molding process. These layers can now be laid down very efficiently and very effectively for specific purposes by way of the current process. This current process is configured to produce a multi-layered product even though it is also well capable of producing a single-layered product.

As illustrated in FIGS. 1A and 1B, the nozzle mechanism 12 includes one or more rows of nozzles 14. These nozzles can be stacked in various configurations, as shown in FIGS. 1E, 1F and 1G, depending on the type of polymers that are extruded. The nozzles 14 are configured to eject polymer into an open mold cavity 16, thereby providing a polymer ejection having substantially zero mold pressure over ambient air pressure. The nozzles 14 are preferably spaced in a substantially adjoining manner, so that the polymer material from each nozzle effectively cascades as a sheet of material, preferably having uniform thickness into the mold cavity 16. Depending on the type, layout and number of mold cavities to be filled, each individual row of nozzle(s) could consist of just one nozzle with long narrow opening 21, 23, as shown respectively in FIGS. 1C and 1D. Alternatively, many nozzles can be employed having smaller openings 20, 22. In the preferred embodiment, a plurality of mold cavities 16 are employed that can have the same or different sizes and cavity patterns, to accommodate various production requirements. The mold cavities 16 are displaced relative to the nozzle mechanism 12 so as to deposit material from one end of a cavity to another with each pass. In the preferred embodiment, the mold cavities 16 are mounted to a shuttle table 18 that shuttles back and forth with respect to a stationary nozzle mechanism 12, to deposit a layer of material during each shuttle pass.

However, it should be appreciated that the shuttle table 18 could alternatively be held stationary and the nozzle mechanism 12 could be displaced so as to deposit a material layer with each pass, all without departing from the invention.

As shown in the figures, the nozzle mechanism 12 includes a first row 20 of nozzles 14 and a second row 22 of nozzles 14. Material is ejected to the nozzles 14, preferably from a respective first extruder/accumulator assembly 24 and a second extruder/accumulator assembly 26. Each extruder/accumulator assembly 24, 26 is preferably configured to dispense a different type of polymer material, though both can dispense the same material if desired. In this way, the nozzle mechanism 12 can dispense multiple layers of polymer with each shuttle pass. It should be appreciated that the nozzle mechanism 12 could include any number of rows with any number of nozzles 14 in each row, in order to control the number of layers, ridges and types of polymers deposited with each shuttle pass. Each row would preferably be configured for receiving material from a respective extruder/accumulator assembly, that would preferably each dispense a different polymer material layer, such material layers being described in detail hereinbelow. Also, each nozzle 14 includes a separate actuator 28, e.g. a servo-motor, for independently turning the nozzle 14 on and off, to establish independent control. These actuators can varyingly control an internal valve in the respective nozzle 14, to vary the size of the effective valve opening or aperture, thereby varying the flow of polymer material through the nozzle 14. To further fine tune the flow of polymer material for better product quality and consistency, a programmable extrusion control mechanism 37 is built in between each extruder/accumulator assembly and the corresponding row of extrusion nozzle(s). The control mechanism 37 is preferably a valve, e.g. a pressure regulator valve. This mechanism serves several purposes. The control mechanism 37 provides surge protection against pressure changes coming out of the extruder/accumulator assembly. It also works to control and regulate the rate and amount of flow of polymer material. It can also functions as a step down pressure control to better manipulate output, thereby providing an added programmable mechanism to the nozzle valves in fine tuning the amount, rate and thickness of extrusion, resulting in better quality output. The same mechanism can also work as a complimentary shut-off valve to the nozzle mechanism, lowering the pressure during nozzle shut off and reducing the wear and tear on the nozzles. Moreover, quick servicing of the nozzle mechanism can easily be accomplished when the polymer conveying line gets turn off using the control mechanism. The control mechanism 37 can be actuated either manually or electronically.

In operation, the layering can be precisely controlled using the nozzle mechanism 12 in a programmed fashion with the shuttle table 18. For example, the extrusion rate through the nozzles 14 can be coordinated with the speed of the shuttle table 18 to deposit layers of various thicknesses with each pass. For example, higher extrusion speed and/or larger valve opening would cooperate with slower table speed to produce a thicker layer, and visa versa to produce a thinner layer. Also, these rates can be varied during a single shuttle pass to produce graduations and localized variations in the thickness of the layers. The rows 20, 21 can be selectively turned on and off so as to only permit precise filling of each cavity 16, and not allow material to spill onto the spaces between cavities, thereby reducing waste. This selective activation can also be employed several times during a single shuttle pass, so as to extrude parallel rows of polymers instead of sheets. Also, individual nozzles 14 within a row can be alternately turned on while others are turned off, so as to extrude parallel rows perpendicular to those formed by selective activation of an entire row. Such rows can be layed down alternately with each shuttle pass, or simultaneously using different respective rows. In this way, layers of polymer rows can be extruded into the cavities 16 that are sandwiched, intertwined or woven together to produce polymer products of any desired internal composition. For example, depending on the selected polymer material and process parameters, these steps could be used in a layer-deposition technique to form internal structural members such as reinforcing ribs, or a shear-resistant weave, or any other structure of any shape that could be formed of deposition layers. Also, the nozzles 14 can be selectively turned on and off so that polymer material is deposited in one mold cavity 16 but not another adjacent mold cavity during a particular shuttle pass. In operation where additional extrusion control is necessary, a converging manifold 25 can optionally be mounted onto the plurality of rows of the nozzle mechanism, as illustrated in FIGS. 1H, 1I. The converging manifold 25 is preferably a longitudinally-extending member that runs the length of the nozzle mechanism and receives the nozzles 14 from at least a portion of the rows. The nozzles 14 may each feed into their own respective converging bores. Alternatively, the nozzles 14 from each row may feed into respective longitudinally-extending converging channels. A valve piece 27 can optionally be equipped on the converging manifold 25 and can be programmed to actuate during the extrusion process to control and vary the overall thickness of the combined multi-layered extrusion or to totally shutoff the extrusion.

In order to cooperate with the nozzle mechanism 12, the shuttle table 18 has several degrees to movement, similar to standard CNC table, enabling the table 18 to move and turn relative to the nozzle mechanism 12. The shuttle table 18 may be mounted on a set of rails to allow transverse motion to the shuttling direction. The table may also optionally be mounted on a rotating turntable so as to create a circular pattern with the extruded layer. Any other type pattern could be created by varying the motion of the mold table 18, including sinusoidal or saw tooth patterns. Also, it may be desirable to incline the nozzle mechanism 12 at an angle θ (e.g. 45 degrees) in order to facilitate the deposition of non-linear layers or rows within a layer.

The present extruder/accumulator assemblies 24, 26 include a typical extruder 30 in which a hopper is filled with unprocessed polymer material and fed into the extruder body where it is melted. An extruder screw 32 is rotated to discharge the melted polymer. As a special feature of the invention, the extruder 30 is used to fill a pair of accumulators 34, 36. The extruder 30 runs continuously to fill a first accumulator 34. When full, the first accumulator 34 ejects the melted polymer toward the nozzle mechanism 12. While the first accumulator 34 ejects, the second accumulator 36 is being filled with polymer. In this way, the extruder 30 runs continuously and the polymer is thereby not overheated. The accumulators 34, 36 can be ejected with a mechanical piston or a pneumatic or hydraulic-actuated ejection means, or other such device as would lend themselves to such an application. For the present application, a single extruder/accumulator assemblies are used for depositing each type of layer material. A directional valve 38 is used at the junction of the respective accumulator lines to govern and regulate the flow of material, particularly in response to the requirements of the nozzle mechanism 12. A respective number of hoppers will be set up with each hopper funneling one or more material into an extruder dedicated for each layer. In the case of a single layer product, all but one hopper/extruder would be turned off, or the same material will be fed through the multiple hoppers for a high speed layering. Each hopper is equipped with ratio device meters to control the quantity of intake materials entering each of the hoppers. The metering could be based on ratios in weight or volume, and the material or materials can be a combination of liquids, flakes, pellets, concentrates, powders, and pre-melted plastics. The types and the numbers of extrusion stations are dependent upon the functionalities and the types of layers to be incorporated into the finished products.

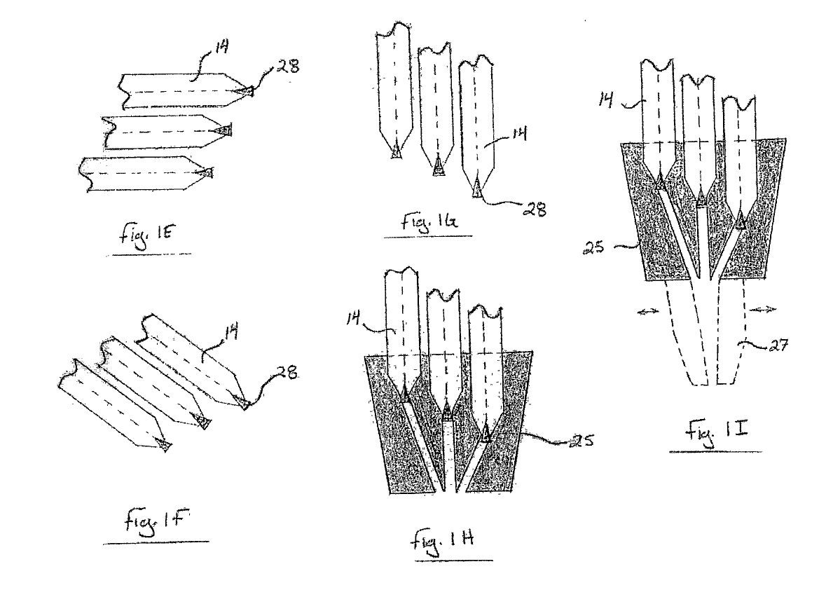

The present molding table 18 can be fashioned to any size to meet the various demands of any variety of production processes. For example, the table can be 4′×4′ or smaller and can be larger than 15′×15′ to accommodate a large number of molds in a variety of sizes. As shown in FIGS. 1A and 2, after the mold cavities 16 are filled with the desired layers, the shuttle table 18 moves into a molding press 40 having a bottom member 42 for receiving and supporting the table 18 and a top member 44 for holding the mating sections 46 of the mold sections into registration. The molding press members 42, 44 are then brought together to mold the finished product. With the current process, polymer is extruded quickly, so that the polymer ejected mass will not have cooled too much before the closing of mold halves occur. Since the polymer mass is laid rather evenly to begin with, as the mold halves close onto each other, the degree of displacement of polymer to fill voids is greatly minimized, thereby creating little to no stress within the polymer article formed. Also, since the polymer is injected at substantially zero mold pressure over ambient air pressure, unlike previous methods, the material is not stressed in this manner, resulting in stronger molded products. The molds are also designed in such a way that they can be heated up and cooled down to maintain a stable molding environment and to improve the surface texture and quality of polymer article. Since the nature of the present method and apparatus is well suited for both prototyping and large and small production runs, the present mold tables 18 are part of a larger shuttle system whereby auxiliary mold tables can be moved in and out of the active production line as molds are being put in and removed, allowing the machine to be in constant production without the need to shut down for mold changes and so on, thus saving a lot of time and purging overheated materials if the machine has to be shut down constantly for mold changes etc.

The present process can also allow for one or more subsequent injection processes for creating additional surface layers on the exterior of the product. For example, a rough product fashioned of inexpensive material can be coated with an exotic or expensive material having a desirable color, tough-coat finish, or other desirable property. For example, a foamed polymer can be fashioned with such a coating to create a thermally-insulated bath tub or other product for maintaining a desired temperature of a liquid. For performing a subsequent injection in accordance with this method, the mold is fashioned to slightly retract to open a void internal space around the molded article, e.g. about 1/16″, for receiving on injection polymer coat. The surrounding internal space could be established by suspending the article by pins, preferably retractably mounted within the mold cavity. In one embodiment, the ejector pins used for ejecting a finished article could also provide this function. One or more injection molding ports 52 are used to inject polymer into the mold to create localized in-filling. The pins 50 could subsequently be used to eject the finished part after cooling of the exterior layer.

In addition to the above, there is also a special embossment mechanism built into the mold for special localized product finish. This special embossment mechanism is designed to work in conjunction with the subsequent injection process whereby the embossment injection would be activated as the molds are coming together, or temporarily slightly pulled apart, creating embossments that are integral parts of the polymer, for engineering, aesthetic, economic, ecological, and/or health and safety reasons, etc. In one aspect of the invention, the embossment mechanism can include a recessed portion of the mold mating section 46 having its own injector port 52. As the mold mating section 46 is first brought into contact with the deposited polymer, the recessed portion would remain a hollow void. A separate embossment injection is made through the injector port 52 to fill the recessed portion. The recessed portion has an edge so as to contain the separately-injected polymer and not allow “bleed-over” to the underlying layer. In this way, the separate embossment injection can simultaneously produce an embossment feature having a different color or other physical property to the underlying layer. By carefully selecting the geometry of the recessed portion, controlling the timing of the embossment injection, and otherwise manipulating the flow of the underlying layer, only a small portion of injected material would be necessary to produce an embossment feature, thus allowing conservation of expensive material.

In another aspect of the invention, the embossment mechanism can also include one or more separate “cookie cutter” sections of the mold mating section 46, each having its own injector port 52, to receive a different color and/or other type material. This can be implemented as a separate reciprocating die section within the mold that can be selectively extended and retracted to provide a localized embossment at the surface of the article prior to a subsequent injection, or over the top of the article after a subsequent injection. For example, such an embossment can be used to apply a decorative rubber design as an anti-skid layer in an isolated region over the underlying layer. Any other specific injection can be applied to a localized spot. In this way, such applications can be performed concurrently with product manufacture to reduce manufacturing steps and process time, thus improving the economics of manufacture.

Having described the process in general, a discussion follows of the various polymer materials that can be used with present method and apparatus. Several types of layer materials are disclosed herewith, any combination of which can be selected in the present method and apparatus for enabling the creation of a variety of products having various layering designs selected to satisfy engineering, aesthetic, economic, ecological and/or health and safety criteria. These layers include but are not limited to the following:

Color/Pigment Layer: With our multi-layer approach, a thin outside color layer can be applied to the main body portion of the product, which could be formed of inexpensive recycled materials. This thin layer is all that is necessary to satisfy the color requirement without subjecting a manufacturer to the excessive high cost of pigment-bearing materials. Plus, the color/pigment could be added to any other layer or additive that could be on the exterior, resulting in further savings. A normal extruder would be used for the extrusion of this layer.

UV Layer: The same multi-layer approach allows us to incorporate one or more outside UV layers to provide for effective protection of the polymer article against harmful ultraviolet radiation from the sun. The added advantage of having outside UV layers instead of applying the UV additive to the whole polymer article is more than just the flexibility of using a higher concentration of UV additive on the outside for a better UV protection without any unnecessary degradation of physical properties, but also the flexibility of using a lower concentration on the layers immediately inside the outside layer, and also the realization of tremendous cost savings.

Anti-Skid Layer: Any anti-skid layer could be formed around a structural body. For example, a linear low density polymer layer could be added as an anti-skid layer to the exterior of an underlying layer (typically high density) of the same material. For example, a soft, frictional anti-skid layer of low-density polyethylene could be applied over a rigid structural body of high-density polyethylene. Many advantages follow from this application of the present method. The layer is formed integrally with no additional labor and handling. Unlike previous-type anti-skid layers, this type of anti-skid layer need not peel off or separate from the underlying layers since it can be selected from the same polymer base but of different density, thus providing a perfect bonding. Since these respective layers are of the same thermoplastic material, the entire product is perfectly recyclable. The desired frictional properties of the anti-skid layer using this approach could be easily adjusted for specific customer requirements by adjusting the density of the resin, since the frictional property of resin is a function to its molecular density. The resulting anti-skid layer is smooth and easily washable, thereby conforming with FDA and USDA requirements for pallet applications. The anti-skid layer can also be color matched to serve as a color layer. A normal extruder would be used for extrusion on this layer.

Fire Retardant Layer: By applying a fire-retardant layer, the overall cost is greatly reduced by providing this a protective layer that serves the same fire-retardant function without using the expensive additive throughout the entire product. The layering also eliminates the heavy weight issue. To minimize the brittleness issues—breaking, cracking and structural problems—a special strength layer is formed within the fire-retardant layer to provide the necessary additional support needed, or by encapsulating it between layers. Since the quantity of fire-retardant additives used is very small when using only a thin layer, the recyclability of the product remains acceptable. A normal extruder will be used for extrusion on this layer.

Strength Layer: In creating a specific strength layer, two separate aspects of technology are applied. The multi-layer process itself provides additional mechanical strength as a well-known inherent property of multiple layers. Also, a specific strength layer can be fashioned to make the polymer super strong and yet recyclable. To achieve the strength requirement, long strand fiberglass, nylon strands and/or other natural fibers such as hemp are blended into the polymer. The material for this layer could be nylon, polyethylene, or polypropylene. In order to maintain length and integrity of the strands, the extruder could cooperate with a downstream feeder that would bypass the shearing of the screw inside the extruder. Another option to introduce a strength layer is to use nylon alone as the engineered polymer for this layer due to its inherent high strength properties. The benefits for making this strength layer possible are numerous. The strength layer allows for the compensation of the lower structural strength of the other layers, thereby allowing utilization of exotic and unique features and materials to achieve functional utilities such as anti-skid, fire-retardant etc.

Foam Layer: A foam layer can be provided for impact resistance, insulation, weight reduction and volume fill. The present multi-layer process provides a desired level of rigidity and impact resistance by varying the materials and thickness of the foam and non-foam layers. An exterior foam layer can also serve as a color layer, anti-skid and strength layer. Furthermore, most of the interior layers have the flexibility of utilizing either virgin or recycled materials. Providing foaming layers also serves an additive function. Improvement in the insulation factor and weight reduction can be achieved throughout a combination of varying the degree of foaming and the thickness of the foam layer. In certain specific applications, foaming is effective for the volume filling of cavities. A foam layer or layers can also add mechanical strength, providing a favorable mass to strength ratio. There are two typical ways to introduce foam to the plastics. One is to use standard extruder with chemical foaming agent mixed in with plastics at the hopper or a downstream location. Another way is to have nitrogen gas introduced midway or downstream of the extruder. In the event a foam layer is employed a specific minimal air pressure applied to the extruded column is critical in preserving the intended degree of foaming for the foam layer and in assuring the intended thickness of the layer or layers.

Barrier Layer: Special impervious material can be applied to the exterior to prevent seeping or movement of content material such as water or solvent through the main body portion. This barrier material can also be combined with a color or other layer. A typical extruder will be used for this purpose. By being able to use a low level of barrier material to ensure a proper barrier, the amount of material cost is greatly reduced, especially for a large plastic product. Moreover, depending on the type of barrier materials used, such materials could have problems with being too expensive and too heavy or rigid if used throughout the whole part. This would not be a problem with the present method, since only a layer of barrier material would be required instead or using such a material throughout the whole part.

Bond Layer: A bond layer could be provided to bond together layers that may otherwise be incompatible and may not bond together well, such as polyethylene and nylon layers. In the case of compatible materials being used between layers that bond well naturally, there will be no need for this bond layer.

Recycled Layer: In order to reduce material costs, a layer of recycled material can be layed down. This layer can be reinforced with other more expensive layers to provide strength, color or any other properties, to provide an inexpensive product having the desirable attributes. The entire product can be formed of recyclable materials, so as to provide a recyclable product.

In another aspect of the invention, the present layering process allows for the addition of inserts and additives. For example, long-fiber fiberglass strands can be added to the molded article by laying them down in between layers. Other materials could be added such as hemp fibers, rubber pieces particulate matter and even liquids. In this way, such additives could be added while avoiding the high heat and shear conditions of the extruder that degrade the materials and break the long fiber strands. As shown in FIG. 2, such strands can be added with a dispenser device 60 suspended above the table 18. The dispenser device 60 can include a shaker for shaking down fibers or particles into the mold cavity 16. The shaker 60 can be oriented to lay fibers in at a desired angle to the mold cavity 16. The shaker 60 can also be made to rotate so as to lay in fibers in a criss-cross direction. Also, multiple shakers could be employed to lay in strands in any desired orientations. This method allows additives to be placed at very specific regions or layers of the molded product.

In addition to including additives, the dispenser device 60 can include a mechanism for incorporating special in-lays, over-lays and inserts to the interior or exterior of the polymer article during molding. Many types of elements can be incorporated by in-mold introduction, such as screws, handles and hinges. For example, the invention allows two molded parts to be formed separately, and a hinge or other component could be placed between the adjoining molds. In this way, a finished part could be formed in situ, eliminating the time and labor of the finishing step and thereby reducing production costs. It would also be possible to add a thermo label for high-quality graphics to the exterior surface of the polymer, and optionally inject a clear protective layer therearound. It is also possible to add an RFID chip/tag to the inside of the polymer article, or a label affixed to the outside having an RFID (i.e. Radio Frequency Identification).

Still further, this process can be used to incorporate structural members. For example, reinforcing members such as rebar can be formed within a polymer product to provide considerable mechanical strength. Also, a steel I-beam can be encased in polymer with the present invention. This has special applicability for steel structural members used in a corrosive environment, e.g. for piers used at the ocean, where a polymer-encased member would resist salt corrosion. Of course, any other types of inserts could be contemplated.

For example, a prefabricated fiberglass mesh could be inserted, having a predetermined shape, and molding could be performed therearound. Also, an armor member, e.g. formed of “Kevlar,” could be embedded to the interior or exterior of a polymer member. In this way, armored components can be formed of polymer, being extremely lightweight compared with previous-type steel armor plating. The present insert molding technique can potentially create a large variety of high-strength, lightweight components, that can be used for fabricating vehicle components, airframes, architectural members and other such applications. For such specified insertion processes, the dispenser device 60 can include a jig for supporting the insert, either manually or robotically placed at a desired position in the mold. The jig could support the insert during one or more layer depositions, or it can be withdrawn after placement, depending on the requirements of a particular process.

In another aspect of the invention, the dispenser device 60 can include a rollout mechanism, equipped to roll out sheet material of any desired length across the shuttle table 18. This roll-out mechanism could also include a cutter to automatically cut the sheet material to any desired length. In this way, such sheet material could be added to one or more mold cavities 16, to further provide for the insertion of objects to provide strength or any other desired physical property. The roll-out mechanism could be oriented to pivot to provide sheet material having any desired orientation. Of course, it should also be appreciated that the roll-out mechanism could include more than one roll-out stations, for dispensing sheet material at any desired orientation, either simultaneously or sequentially, to suit the requirements of a desired process.

By carefully providing pin-point control of polymer deposition, the present method enables a shape to be generally deposited around the insert. In one aspect of the invention, the mating mold section 46 would also be used for finishing detail, with a minimum of polymer dislocation and flash thereby minimizing material stress. Also, by carefully controlling insert placement, the fluid displacement of the molten polymer resulting from the weight of the insert can be calculated and controlled, allowing for tight tolerances to be maintained.

It should be appreciated that the present method and apparatus is sufficiently versatile to allow perform traditional injection molding operations, traditional compression molding operations, or a combination of injection and compression processes. The injection mechanism could be fashioned from a multi-nozzle hot runner system to a single nozzle system on one or both sides of the presses.

As will be realized, the invention is capable of other and different embodiments and its several details are capable of modifications in various respects, e.g. for engineering, aesthetic, economical, ecological, and/or health and safety reasons, etc., all without departing from the invention. Accordingly, the drawings and description are to be regarded as illustrative and not restrictive. As described hereinabove, the present invention solves may problems associated with previous type devices. However, it will be appreciated that various changes in the details, materials and arrangements of parts which have been herein described and illustrated in order to explain the nature of the invention may be made by those skilled in the area within the principle and scope of the invention will be expressed in the appended claims.

We claim:

1. A molding process comprising the steps of:
depositing at least one extruded polymer into a mold cavity having a predetermined surface profile, wherein the at least one extruded polymer is deposited into the mold cavity with a predetermined pattern at substantially zero mold pressure above ambient air pressure;
enclosing the mold cavity with a mating mold section to produce a molded polymer article.

2. The molding process of claim 1 further comprising a step of displacing at least one of the at least one extruded polymer and the mold cavity during the step of depositing, so as to lay down at least a portion of a layer of extruded polymer into the mold cavity.

3. The molding process of claim 2 wherein the step of depositing at least one extruded polymer comprises extruding a plurality of rows of at least one type of extruded polymer, so as to lay down a respective plurality of layer portions of extruded polymer into the mold cavity.

4. The molding process of claim 3 wherein the step of extruding a plurality of rows comprises extruding a plurality of different polymer materials, so as to form a multi-layered, composite product.

5. The molding process of claim 4 wherein the plurality of different polymer materials comprises at least one of a color/pigment layer, a UV layer, an anti-skid layer, a fire-retardant layer, a foam layer, a barrier layer, a recycled layer, and a bonding layer for bonding between incompatible materials.

6. The molding process of claim 4 wherein the step of extruding a plurality of rows comprises extruding from a plurality of rows of adjacent nozzles, spaced in a substantially adjoining manner, so that the polymer material from each row of nozzles effectively cascades as a sheet of material into the mold cavity.

7. The molding process of claim 4 wherein the step of extruding a plurality of rows comprises extruding from a plurality of nozzles, wherein each nozzle has a long narrow opening, so that the polymer material from each nozzle effectively cascades as a sheet of material into the mold cavity.

8. The molding process of claim 3 wherein the step of extruding a plurality of rows comprises varying the displacing at least one of the at least one extruded polymer and the at least one mold cavity so as to vary thickness of the at least a portion of a layer.

9. The molding process of claim 8 wherein the step of varying the displacing comprises varying to produce graduations and localized variations in the thickness of the layers.

10. The molding process of claim 8 wherein the step of varying the displacing comprises selectively activating the depositing of the extruded polymer so as to only permit precise filling of the mold cavity, and not allow material to spill onto the spaces between cavities, thereby reducing waste.

11. The molding process of claim 8 wherein the step of varying the displacing comprises selectively activating the depositing of the extruded polymer a plurality of times during the step of depositing, as to extrude a plurality of parallel rows of polymer.

12. The molding process of claim 11 wherein the steps of depositing and selectively activating are repeated a predetermined number of times so as to deposit a plurality of perpendicular layers of rows that are at least one of sandwiched, intertwined and woven together.

13. The molding process of claim 2 wherein the step of displacing comprises varying the motion between the at least one extruded polymer and the at least one mold cavity during the step of depositing so as to produce a predetermined pattern.

14. The molding process of claim 13 wherein the step of varying the motion comprises creating at least one of a circular pattern, a sinusoidal pattern, and a saw tooth pattern.

15. The molding process of claim 13 wherein the step of varying the motion comprises inclining at an angle so as to deposit a non-linear layer.

16. The molding process of claim 2 wherein the step of displacing comprises shuttling the at least one mold cavity back and forth and holding stationary the extruded polymer so as to deposit a layer of material from one end of a cavity to another during each shuttle pass.

17. The molding process of claim 2 wherein the step of displacing comprises shuttling the extruded polymer back and forth and holding the at least one mold cavity stationary so as to deposit a layer of material from one end of a cavity to another during each shuttle pass.

18. The molding process of claim 1 wherein the step of depositing at least one extruded polymer into at least one mold cavity comprises depositing into a plurality of mold cavities.

19. The molding process of claim 15 wherein the plurality of mold cavities have at least one of a same size and cavity pattern and at least one different size and cavity pattern.

20. The molding process of claim 1 further comprising a step of varying the rate of depositing the at least one extruded polymer, so as to vary extrusion thickness.

21. The molding process of claim 1 wherein the step of depositing is performed so as to lay the extruded polymer evenly into the into mold cavity, so as to substantially minimize displacement of the extruded polymer upon the step of enclosing, so as to substantially reduce stress in the molded polymer article.

22. The molding process of claim 1 further comprising the step of selectively heating and cooling the respective mold cavities so as to maintain a stable molding environment and to improve the surface texture and quality of the molded polymer article.

23. The molding process of claim 1 further comprising at least one subsequent injection process for creating at least one portion of an additional surface layer on the exterior of the molded article.

24. The molding process of claim 23 wherein at least one subsequent injection process comprises retracting at least one of the mold cavity and the mating mold section to open a void internal space around the molded article for receiving on injection polymer coat.

25. The molding process of claim 24 wherein the step of retracting further comprises establishing the void internal space by suspending the molded article on retractable pins mounted within the mold cavity.

26. The molding process of claim 25 wherein the step of suspending the molded article comprises using ejector pins for the retractable pins, wherein the ejector pins are also used in a step of ejecting the molded article from the mold.

27. The molding process of claim 23 wherein the at least one subsequent injection process comprises creating at least one additional surface layer selected from at least one of a color layer and a tough-coat finish layer.

28. The molding process of claim 23 wherein the at least one subsequent injection process comprises an embossment step for creating a localized product finish on a portion of the molded article.

29. The molding process of claim 28 wherein the embossment step is performed by providing a recessed portion in at least one of the mold cavity and the mating mold section and injecting an embossment injection to fill the recessed portion.

30. The molding process of claim 29 wherein the recessed portion's geometry and the embossment injection's timing are controlled so as to conserve embossment injection material.

31. The molding process of claim 28 wherein the embossment step is performed by providing at least one reciprocating die section within in at least one of the mold cavity and the mating mold section that is selectively extended and retracted from the molded article, and injecting an embossment injection to fill the at least one reciprocating die section, to form a localized embossment at the surface of the molded article.

32. The molding process of claim 31 wherein the localized embossment is performed in conjunction with a further subsequent injection step for creating at least one portion of an additional surface layer on the exterior of the molded article, wherein the embossment step is performed at least one of: prior to the subsequent injection step; and over the top of the molded article after the subsequent injection step.

33. The molding process of claim 28 wherein the embossment is used to apply an applique that is at least one of a decorative layer and an anti-skid layer over an isolated region of the molded article.

34. The molding process of claim 1 further comprising a dispensing step for adding a material to the molded article prior to the step of enclosing.

35. The molding process of claim 34 wherein the dispensing step is performed by adding the material to the extruded polymer prior to the step of depositing.

36. The molding process of claim 34 wherein the dispensing step is performed by adding the material to the extruded polymer after the step of depositing.

37. The molding process of claim 34 wherein the dispensing step comprises adding at least one of long strand fiberglass, nylon strands, hemp fibers, rubber pieces, particulate matter and liquids, so as to create a strength layer within the extruded polymer.

38. The molding process of claim 34 wherein the step of depositing comprises a plurality of depositing steps and wherein the step of dispensing is performed between a respective plurality of depositing steps so that the material is dispensed between respective polymer layers.

39. The molding process of claim 34 wherein the dispensing step is performed by shaking down the material into the mold cavity.

40. The molding process of claim 39 wherein the step of shaking is performed so as to dispense the material at a desired angle to the mold cavity.

41. The molding process of claim 39 wherein the step of shaking includes a step of rotating so as to dispense the material in criss-crossing directions.

42. The molding process of claim 39 wherein the step of shaking includes a step of rotating so as to dispense the material in criss-crossing directions.

43. The molding process of claim 39 wherein the dispensing step includes incorporating an element into the extruded polymer molded article by in-mold introduction prior to the step of enclosing.

44. The molding process of claim 43 wherein the step of incorporating comprises inlaying an element into at least an interior portion of the molded article.

45. The molding process of claim 44 wherein the step of inlaying is performed so that a portion of element is exterior to the molded article.

46. The molding process of claim 45 wherein the elements are selected from a group including screws, handles and hinges.

47. The molding process of claim 45 wherein the step of depositing is performed into a plurality of mold cavities and wherein the step of inlaying is performed so that the element is placed between adjoining mold cavities so as be formed between respective molded parts.

48. The molding process of claim 44 wherein the step of incorporating comprises inserting the element within the interior of the molded article.

49. The molding process of claim 48 wherein the step of inserting comprises inserting at least one of: a radio frequency identification chip; a reinforcing structural member, including at least one of a rebar and an I-beam, to provide mechanical strength; a prefabricated fiberglass mesh having a predetermined shape; and an armor member.

50. The molding process of claim 43 wherein the step of incorporating comprises applying an overlay to the exterior of the molded article prior to the enclosing step.

51. The molding process of claim 50 further comprising a step of subsequently injecting a protective layer around the overlay and the exterior surface of the molded article.

52. The molding process of claim 43 wherein the step of incorporating comprises supporting the element at a desired position in the mold.

53. The molding process of claim 52 wherein the step of depositing comprises a plurality of depositing steps and wherein the step of supporting comprises supporting the element through at least a portion of the plurality of depositing steps.

54. The molding process of claim 43 wherein the step of incorporating comprises rolling out sheet material across the mold cavity.

55. The molding process of claim 54 wherein the step of rolling out comprises a step of cutting the sheet material to a predetermined length.

56. The molding process of claim 54 wherein the step of rolling out comprises pivoting to provide the sheet material with a predetermined orientation.

57. A molding apparatus comprising:
a nozzle mechanism for depositing at least one layer of polymer;
at least one mold cavity for receiving the at least one layer of polymer;
a displacement arrangement for displacing at least one of the nozzle mechanism and the at least one mold cavity while the polymer is being deposited, so as to deposit at least a portion of a layer of polymer into the mold cavity during a displacement pass; and
at least one respective mating mold section for enclosing with the at least one mold cavity to produce a at least one respective molded polymer article.

58. The molding apparatus of claim 57 wherein the mold cavity is one of a plurality of mold cavities each having at least one of the same size and a different size and cavity pattern from the respective others.

59. The molding apparatus of claim 57 wherein the displacement arrangement is configured to displace the mold cavity relative to the nozzle mechanism so as to deposit material from one end of a cavity to another with each pass.

60. The molding apparatus of claim 59 wherein the displacement arrangement comprises a shuttle table that supports the mold cavity and shuttles back and forth with respect to a stationary nozzle mechanism, to deposit a layer of material during each shuttle pass.

61. The molding apparatus of claim 59 wherein the shuttle table is configured to have several degrees to movement, enabling the mold cavity to move and turn relative to the nozzle mechanism.

62. The molding apparatus of claim 61 wherein the shuttle table is mounted on a set of rails to allow transverse motion to the displacement pass's direction.

63. The molding apparatus of claim 61 wherein the shuttle table is mounted on a rotating turntable so as to create a circular pattern with the deposited layer.

64. The molding apparatus of claim 61 wherein the shuttle table is configured to vary the motion of the mold cavity so as to produce one of a sinusoidal pattern and a saw tooth pattern.

65. The molding apparatus of claim 60 wherein the shuttle table is part of a shuttle system whereby a plurality of shuttle tables are moved in and out from the nozzle mechanism, allowing the molding apparatus to be in constant production.

66. The molding apparatus of claim 57 wherein the displacement arrangement is configured to displace the nozzle mechanism relative to the mold cavity so as to deposit material from one end of a cavity to another with each pass.

67. The molding apparatus of claim 57 wherein the nozzle mechanism comprises at least one nozzle with long narrow opening so that polymer from the nozzle effectively cascades as a sheet of material into the mold cavity.

68. The molding apparatus of claim 57 wherein the nozzle mechanism comprises at least one row of nozzles spaced in a substantially adjoining manner, so that polymer from each nozzle effectively cascades as a sheet of polymer material into the mold cavity.

69. The molding apparatus of claim 68 wherein the nozzle mechanism comprises a plurality of rows of nozzles so that polymer from each row of nozzles effectively cascades as a separate sheet of material into the mold cavity.

70. The molding apparatus of claim 69 wherein the plurality of rows of nozzles are configured to each dispense one of a plurality of different types of polymer material, so as to dispense multiple layers of polymer with each pass.

71. The molding apparatus of claim 70 wherein each of the plurality of rows of nozzles receive material from a respective extruder/accumulator assembly that each dispense one of a plurality of different types of polymer material.

72. The molding apparatus of claim 69 wherein respective nozzles in each of the plurality of rows comprise a converging manifold so that polymer from each row of nozzles effectively cascades as a multi-layer extrusion of material into the mold cavity.

73. The molding apparatus of claim 72 further comprising a valve piece, mounted to the converging manifold, and actuable to selectively control and vary the flow of the combined multi-layered extrusion, to selectively vary the thickness of the multi-layer extrusion.

74. The molding apparatus of claim 73 wherein each nozzle includes a separate actuator for independently turning the nozzle on and off, to establish independent actuator control.

75. The molding apparatus of claim 69 further comprising an internal valve in each respective nozzle, controlled by the respective actuator, for varying the size of the effective valve opening or aperture, thereby varying the flow of polymer material through the nozzle.

76. The molding apparatus of claim 69 wherein the independent actuator control causes at least one of: a portion of the nozzles within a row to be turned on while respective other nozzles are turned off, so as to extrude parallel rows of polymer material with each pass; and the nozzles within a row to be turned on for at least one portion of each pass and turned off for at least another portion of each pass, so as to extrude parallel rows of polymer material with each pass.

77. The molding apparatus of claim 76 the independent actuator control is operative over a plurality of displacement passes, so as to extrude a plurality of rows from the nozzles that are at least one of sandwiched, intertwined and woven together.

78. The molding apparatus of claim 69 wherein the at least one mold cavity is one of a plurality of mold cavities, and wherein the independent actuator control selectively turns the nozzles on and off so that polymer material is deposited into a first mold cavity but not a second adjacent mold cavity during a particular displacement pass.

79. The molding apparatus of claim 68 wherein the at least one row of nozzles are inclined at an angle for non-linear deposition within a layer.

80. The molding apparatus of claim 57 further comprising at least one extruder/accumulator assembly for supplying polymer material to the nozzle mechanism.

81. The molding apparatus of claim 80 further comprising an extrusion control mechanism, located between the extruder/accumulator assembly and the nozzle mechanism, so as to selectively control and regulate the rate and amount of flow of polymer material through the nozzle mechanism.

82. The molding apparatus of claim 80 wherein the extruder/accumulator assembly comprises a hopper filled with unprocessed polymer material, an extruder body for receiving and melting the polymer material, and an extruder screw that is rotated to discharge the melted polymer.

83. The molding apparatus of claim 80 wherein the extruder/accumulator assembly comprises an extruder and a plurality of accumulators, such that the extruder fills a first accumulator, and when full, the first accumulator ejects melted polymer toward the nozzle mechanism, and while the first accumulator ejects, the extruder fills a second accumulator, so that the extruder runs continuously and the polymer is thereby not overheated.

84. The molding apparatus of claim 83 wherein the respective accumulators are ejected using one of a mechanical piston, a pneumatic-actuated ejection means and a hydraulic-actuated ejection means.

85. The molding apparatus of claim 84 further comprising a directional valve, placed at a junction of the respective accumulators, to govern and regulate the flow of polymer.

86. The molding apparatus of claim 57 wherein the nozzle mechanism is configured to evenly deposit polymer into the mold cavity so as to reduce displacement of polymer as the mold cavity and mating mold section close together, thereby reducing stress within the polymer article.

87. The molding apparatus of claim 57 wherein at least one of the mold cavity and the mating mold section comprise means for heating and cooling to maintain a stable molding environment and to improve the surface texture and quality of polymer article.

88. The molding apparatus of claim 57 further comprising means for subsequent injection including:
at least one retractable mold portion formed on at least one of the mold cavity and the mating mold section, retractable to open a void internal space around the molded article; and
at least one injection molding port to inject polymer into the retractable mold portion to create at least a portion of an additional surface layer on the exterior of the product.

89. The molding apparatus of claim 88 further comprising at least one retractable pin, retractably mounted within at least one of the mold cavity and the mating mold section, for suspending the molded article and thereby establish the surrounding internal space.

90. The molding apparatus of claim 89 wherein the at least one retractable pin comprises a respective ejector pin for ejecting the molded article after cooling of the exterior layer.

91. The molding apparatus of claim 90 wherein the at least one retractable pin comprises a respective ejector pin for ejecting the molded article after cooling of the exterior layer.

92. The molding apparatus of claim 88 wherein the additional surface layer is selected from a group including a color layer and a tough-coat finish layer.

93. The molding apparatus of claim 57 further comprising an embossment mechanism built into at least one of the mold cavity and the mating mold section for applying a localized product finish on a portion of the molded article.

94. The molding apparatus of claim 93 wherein the embossment mechanism comprises:
a recessed portion in at least one of the mold cavity and the mating mold section; and
an injector port for filling the recessed portion.

95. The molding apparatus of claim 93 wherein the embossment mechanism comprises:
at least one reciprocating die section within at least one of the mold cavity and the mating mold section that is selectively extended and retracted from the molded article; and
an injection port for injecting an embossment injection to fill the at least one reciprocating die section, to form a localized embossment at the surface of the molded article.

96. The molding apparatus of claim 95 wherein the localized embossment is performed in conjunction with a further subsequent injection step for creating at least one portion of an additional surface layer on the exterior of the molded article, wherein the embossment step is performed at least one of: prior to the subsequent injection step; and over the top of the molded article after the subsequent injection step.

97. The molding apparatus of claim 93 wherein the embossment is an applique that is at least one of a decorative layer and an anti-skid layer over an isolated region of the molded article.

98. The molding process of claim 57 wherein the at least one polymer layer is selected from group including a color/pigment layer, a UV layer, an anti-skid layer, a fire-retardant layer, a foam layer, a barrier layer, a recycled layer, and a bond layer to bond together layers that may otherwise be incompatible.

99. The molding apparatus of claim 57 further comprising a dispensing device for adding a material to the molded article prior to enclosing the mold cavity and the mating mold section.

100. The molding apparatus of claim 99 wherein the molding apparatus comprises an extruder having an extruder screw that supplies polymer to the nozzle mechanism, and wherein the dispensing device comprises a downstream feeder that adds the material downstream of the extruder screw but to the nozzle mechanism for depositing the polymer into the mold cavity.

101. The molding apparatus of claim 99 wherein the dispensing device is configured to add the material to the at least one layer of polymer after depositing in the mold cavity.

102. The molding apparatus of claim 99 wherein the dispensing device is configured to add at least one of long strand fiberglass, nylon strands, hemp fibers, rubber pieces, particulate matter and liquids, so as to create a strength layer within the extruded polymer.

103. The molding apparatus of claim 99 wherein the at least one layer deposited by the nozzle mechanism is a plurality of layers and wherein the dispensing device is configured to dispense the material between respective polymer layers.

104. The molding apparatus of claim 99 wherein the dispensing device comprises at least one shaker for shaking down the material into the mold cavity.

105. The molding apparatus of claim 104 wherein the at least one shaker is configured to dispense the material at a desired angle to the mold cavity.

106. The molding apparatus of claim 104 wherein the at least one shaker is rotatable so as to dispense the material in criss-crossing directions.

107. The molding apparatus of claim 104 wherein the at least one shaker comprises a plurality of shakers configured so as to dispense the material in criss-crossing directions.

108. The molding apparatus of claim 104 wherein the dispensing device includes a mechanism for incorporating an element into the at least one polymer layer by in-mold introduction enclosing the mold cavity and the mating mold section.

109. The molding apparatus of claim 108 wherein the mechanism is configured to inlay the element into at least an interior portion of the molded article.

110. The molding apparatus of claim 109 wherein the mechanism is configured to inlay the element so that a portion of element is exterior to the molded article.

111. The molding apparatus of claim 110 wherein the elements are selected from a group including screws, handles and hinges.

112. The molding apparatus of claim 110 wherein the mold cavity comprises a plurality of mold cavities and wherein the mechanism is configured to inlay the element between adjoining mold cavities so as be joined to respective molded parts.

113. The molding apparatus of claim 109 wherein the mechanism is configured to insert the element within the interior of the molded article.

114. The molding apparatus of claim 113 wherein the element comprises at least one of: a radio frequency identification chip; a reinforcing structural member, including at least one of a rebar and an I-beam, to provide mechanical strength; a prefabricated fiberglass mesh having a predetermined shape; and an armor member.

115. The molding apparatus of claim 108 wherein the mechanism is configured to apply an overlay to the exterior of the molded article prior to enclosing the mold cavity and the mating mold section.

116. The molding apparatus of claim 115 further comprising means for subsequently injecting a protective layer around the overlay and the exterior surface of the molded article.

117. The molding apparatus of claim 108 wherein the mechanism comprises a jig for supporting the element at a desired position in the mold.

118. The molding apparatus of claim 117 wherein the at least one polymer layer comprises a plurality of polymer layers and wherein the jig is configured to support the element through at least a portion of the plurality of layers.

119. The molding apparatus of claim 108 wherein the mechanism comprises a roll-out mechanism for rolling out sheet material across the mold cavity.

120. The molding apparatus of claim 119 wherein roll-out mechanism comprises a cutter for cutting the sheet material to a predetermined length.

121. The molding apparatus of claim 119 wherein the roll-out mechanism is configured to pivot to provide the sheet material with a predetermined orientation.
